(19) United States
(12) Patent Application Publication
(10) Pub. No.: US 2026/0348881 A1
(43) Pub. Date: Nov. 5, 2026

(54) MULTI-CHANNEL FAST X-RAY COMPUTED TOMOGRAPHY APPARATUS AND METHOD

(71) Applicant: Scientific Gear Service Co., Ltd., Miaoli County (TW)

(72) Inventors: CHING-SHUN KU, Miaoli County (TW); Chia-Hsien Lin, Miaoli County (TW); Bo-Shu Tsai, Miaoli County (TW); Lin-Sheng Fu, Miaoli County (TW)

(21) Appl. No.: 19/640,785

(22) Filed: Apr. 7, 2026

Related U.S. Application Data
(60) Provisional application No. 63/798,056, filed on May 1, 2025.

(51) Int. Cl. G01N 23/046

(52) U.S. Cl. CPC G01N 23/046; G01N 2223/3307; G01N 2223/419; G01N 2223/42; G01N 2223/501

(57) ABSTRACT

A multi-channel fast X-ray computed tomography apparatus comprises a stage, an X-ray generator, and a plurality of detectors. The stage comprises a moving unit for carrying and moving a test object. The stage has a zone comprising a plurality of imaging regions. The X-ray generator is disposed on one side of the stage to emit an X-ray toward the zone of the stage. The detectors are disposed on the other side of the stage and within the angular range of the transmitted X-rays. The detectors are respectively positioned corresponding to the imaging regions to receive the X-ray passing through the corresponding imaging regions at different angles to obtain a plurality of images. Wherein, when the test object moves within the zone, the view regions of the test object sequentially pass through the imaging regions and the detectors acquire the images of each view region of the test object.

### BACKGROUND OF THE INVENTION

### 1. Field of the invention

The present invention relates to a multi-channel fast X-ray computed tomography apparatus and method, and more particularly, to a multi-channel fast X-ray computed tomography apparatus and method used in semiconductor field.

### 2. DESCRIPTION OF THE PRIOR ART

With the rapid development of technology, semiconductor devices have been widely used in various fields, including consumer electronics, communication devices, electric vehicles, artificial intelligence, and high-performance computing. They have become an indispensable core technology in all types of critical systems. Wherein, with the continuous advancements in manufacturing processes, the structures of semiconductor components have become increasingly complex, resulting in reduced yield. How to effectively detect internal structural defects in semiconductor components and enhance inspection efficiency has thus become a critical issue in semiconductor manufacturing and quality control.

However, conventional X-ray computed tomography scanners typically use a single X-ray source paired with a single two-dimensional detector. The scanning method typically involves either rotating a sample via a scanning mechanism, coordinated circular motion of both the sample and the detector, or performing an offset movement of the light source and the detector while the sample remains stationary, to obtain two-dimensional images of the sample from different angles. Specifically, at any time point, prior art can only obtain a single image of a single specific region of the sample from a specific angle using a set of two-dimensional detectors. It requires a sample scanning mechanism to move the sample sequentially to different angles to obtain multiple images of the same specific region from different angles. Only after this process is completed can scanning proceed to another specific region of the sample. This workflow is repeated iteratively. Wherein, assuming the exposure time is T1, and the time taken for the sample to move from one angle to the next is T2. When obtaining X images of a specific region from different angles for 3D reconstruction, the total acquisition time is T = X(T1 + T2).Thus, to capture complete images of the sample from multiple angles across different regions, it is necessary not only to repeatedly wait for the sample scanning mechanism to reposition itself but also to repeatedly capture images of each specific region from different angles. This results in an increased overall scanning time and exposes samples to higher cumulative radiation doses, rendering radiation-sensitive semiconductor components impractical for X-ray computed tomography analysis.

Therefore, there is an urgent need for a new type of multi-channel fast X-ray computed tomography apparatus to address the issues of prior art.

### SUMMARY OF THE INVENTION

In view of this, embodiments of the present invention provide a multi-channel fast X-ray computed tomography apparatus including a stage, an X-ray generator and a plurality of detectors. The stage includes a moving unit configured to carry and drive a test object to move, and has a zone including a plurality of imaging regions. The X-ray generator is disposed on one side of the stage and configured to emit an X-ray toward the zone of the stage. The detectors are disposed on the other side of the stage and within an angular range of transmitted X-ray. The detectors are respectively disposed corresponding to the imaging regions to receive the X-ray passing through the corresponding imaging regions from different angles to obtain a plurality of images. Wherein, the moving unit drives the test object from outside the imaging regions into the zone and moves the test object within the zone in a scanning motion. When the test object moves within the zone, a plurality of view regions of the test object sequentially pass through the imaging regions, and the detectors obtain the images for each of the view regions of the test object.

Wherein, the detectors are arranged in an array. When the test object moves within the zone, a first detector among the detectors obtains the images of the view regions from the same angle at a plurality of time points, and the detectors respectively obtain the images of the view regions from different angles at the same time point.

Wherein, the multi-channel fast X-ray computed tomography apparatus further includes a reconstruction module connected to the detectors. The reconstruction module is configured to receive the images from the detectors and reconstruct a 3D tomographic image for each of the view regions of the test object based on the images.

Wherein, a second detector among the detectors includes a first detecting surface and a second detecting surface. The first detecting surface and the second detecting surface respectively receive the X-ray from different angles to generate the images at different angles, wherein the first detecting surface and the second detecting surface are formed by partitioning one detecting surface of the second detector through a software.

Wherein, the reconstruction module includes at least one artificial intelligence (AI) model. The at least one AI model is configured to perform a denoising process on the images to generate a high-quality two-dimensional image, perform a sparse 3D reconstruction process on the high-quality two-dimensional image to generate a full-view 3D image, and perform a super-resolution process on the full-view 3D image to generate a high-resolution 3D tomographic image. Wherein, a training dataset used for training the at least one AI model comprises datasets of long-exposure images and short-exposure images for different sample forms, datasets of large-angle images and small-angle images, and datasets of segmented and non-segmented images for imaging regions

Wherein, the imaging regions are arranged in an array, and at least one interval is disposed between the adjacent imaging regions.

Wherein, the multi-channel fast X-ray computed tomography apparatus further includes a mask module disposed between the X-ray generator and the stage and corresponding to the at least one interval. The mask module is configured to block the X-ray emitted by the X-ray generator from passing through the at least one interval.

Embodiments of the present invention also provides a multi-channel fast X-ray computed tomography method including the following steps: placing a test object on a moving unit of a stage to enable the test object to move, wherein the stage has a zone and the zone comprises a plurality of imaging regions; and disposing a plurality of detectors on one side of the stage and within an angular range of transmitted X-ray emitted by an X-ray generator, the detectors being respectively disposed corresponding to the imaging regions to enable the detectors to receive the X-ray passing through the corresponding imaging regions from different angles, thereby obtaining a plurality of images. Wherein, the moving unit drives the test object from outside the imaging regions into the zone and moves the test object within the zone by scanning motion. When the test object moves within the zone, a plurality of view regions of the test object sequentially pass through the imaging regions, and the detectors obtain the images for each of the view regions of the test object.

Wherein, the detectors are arranged in an array. When the test object moves within the zone, a first detector of the detectors obtains the images of the view regions from the same angle at a plurality of time points, and the detectors respectively obtain the images of the view regions from different angles at the same time point.

Wherein, the multi-channel fast X-ray computed tomography method includes the following step: receiving the images by a reconstruction module, and reconstructing a 3D tomographic image for each of the view regions of the test object based on the images.

Wherein, a second detector of the detectors includes a first detecting surface and a second detecting surface. The first detecting surface and the second detecting surface respectively receive the X-ray from different angles to generate the images at different angles, wherein the first detecting surface and the second detecting surface are formed by partitioning one detecting surface of the second detector through a software.

Wherein, the multi-channel fast X-ray computed tomography method includes the following step: receiving the images generated by the detectors using the reconstruction module, and performing a denoising process by at least one AI model of the reconstruction module to generate a high-quality image, performing a sparse 3D reconstruction process on the high-quality image to generate a full-view image, and performing a super-resolution process on the full-view image to generate a high-resolution image. Wherein a training dataset used for training the at least one AI model comprises datasets of long-exposure images and short-exposure images for different sample forms, datasets of large-angle images and small-angle images, and datasets of segmented and non-segmented images for imaging regions.

Wherein, the imaging regions are arranged in an array, and at least one interval is disposed between the adjacent imaging regions.

Wherein, the multi-channel fast X-ray computed tomography method includes the following step: blocking the X-ray emitted by the X-ray generator from passing through the at least one interval by a mask module, wherein the mask module is disposed between the X-ray generator and the stage and corresponding to the at least one interval.

In summary, the present invention not only obtains images of a single view region. Rather, it simultaneously obtains images for a plurality of imaging regions from different angles by a plurality of detectors based on the movement of a test object on a stage to shorten imaging time, thereby reducing the cumulative radiation dose of the test object and ensuring it remains undamaged after detection. At the same time, the present invention can also perform multiple rounds of repeated scanning by adjusting the position of the imaging regions of the stage and its corresponding detectors to obtain more images, thereby enhancing the performance of subsequent 3D reconstruction. Additionally, the detectors of the present invention can be partitioned into multiple detecting surfaces by software to generate more images from different angles, thereby facilitating subsequent 3D reconstruction. Furthermore, the present invention can also include an image processing module, which performs three-dimensional reconstruction on a plurality of images using at least one AI model, detects and removes artifacts to generate a high-resolution 3D tomographic image.

### BRIEF DESCRIPTION OF THE APPENDED DRAWINGS

FIG. 1 is a schematic diagram illustrating a multi-channel fast X-ray computed tomography apparatus according to an embodiment of the present invention.

FIG. 2 is a front-view schematic diagram illustrating a multi-channel fast X-ray computed tomography apparatus according to an embodiment of the present invention.

FIG. 3 is a top-view schematic diagram illustrating a multi-channel fast X-ray computed tomography apparatus according to an embodiment of the present invention.

FIG. 4 is a front-view schematic diagram illustrating a multi-channel fast X-ray computed tomography apparatus according to another embodiment of the present invention.

FIG. 5 is a top-view schematic diagram illustrating a multi-channel fast X-ray computed tomography apparatus according to another embodiment of the present invention.

FIG. 6 is a top-view schematic diagram illustrating a multi-channel fast X-ray computed tomography apparatus according to another embodiment of the present invention.

FIG. 7 is a schematic diagram illustrating a multi-channel fast X-ray computed tomography apparatus according to another embodiment of the present invention.

FIG. 8 is a flow diagram illustrating a multi-channel fast X-ray computed tomography method according to an embodiment of the present invention.

FIG. 9 is a flow diagram illustrating a multi-channel fast X-ray computed tomography method according to another embodiment of the present invention.

FIG. 10 is a flow diagram illustrating a multi-channel fast X-ray computed tomography method according to another embodiment of the present invention.

### DETAILED DESCRIPTION OF THE INVENTION

For the sake of the advantages and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments.

In the descriptions of this specification, the terms “an embodiment,” “another embodiment,” or “some embodiments” refer to at least one embodiment of the present invention that includes the specific features, structures, materials, or characteristics described in the embodiment. In this specification, the illustrative expressions of the above terms do not necessarily refer to the same embodiment. Furthermore, the specific features, structures, materials, or characteristics described may be combined in any one or more embodiments in an appropriate manner.

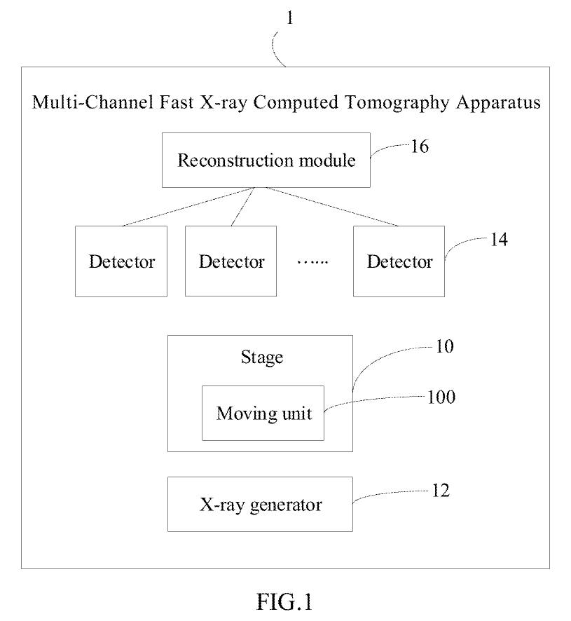

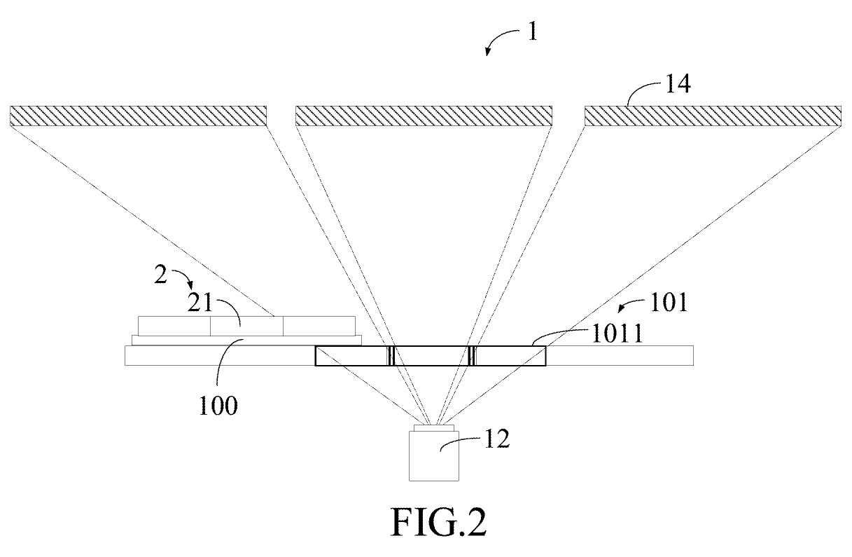

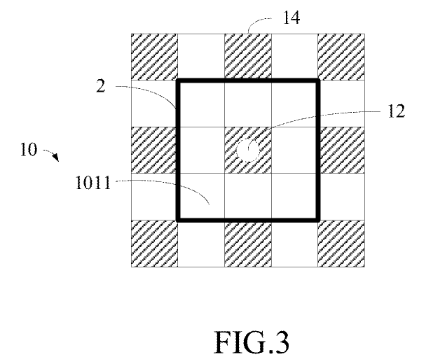

Please refer to FIGS. 1-3 . FIG. 1 is a schematic diagram illustrating a multi-channel fast X-ray computed tomography apparatus 1 according to an embodiment of the present invention. FIG. 2 is a front-view schematic diagram illustrating the multi-channel fast X-ray computed tomography apparatus 1 according to an embodiment of the present invention. FIG. 3 is a top-view schematic diagram illustrating the multi-channel fast X-ray computed tomography apparatus 1 according to an embodiment of the present invention. As shown in FIGS. 3-3 , in the present embodiment, the multi-channel fast X-ray computed tomography apparatus 1 includes a stage 10, an X-ray generator 12, a plurality of detectors 14, and a reconstruction module 16. The stage 10 includes a moving unit 100 configured to carry a test object 2 and drive it to move. The stage 10 has a zone 101, which includes a plurality of imaging regions 1011. As shown in FIG. 3, the imaging regions 1011 can be arranged in an array within the zone 101. The X-ray generator 12 is disposed on one side of the stage 10 and is configured to emit X-rays toward the zone 101 of the stage 10. The detectors 14 are disposed on the other side of the stage 10 and within the angular range of the transmitted X-rays. The detectors 14 are respectively disposed corresponding to the imaging regions to receive the X-rays passing through the corresponding imaging regions from different angles, thereby obtaining a plurality of images. Wherein, the moving unit 100 drives the test object 2 from outside the imaging regions 1011 into the zone 101 and moves the test object 2 within the zone 101 in a scanning motion. When the test object 2 moves within the zone 101, a plurality of view regions 21 of the test object 2 sequentially pass through the imaging regions 1011, the X-rays emitted by the X-ray generator 12 pass through the view regions 21 of the test object 2, and the detectors 14 respectively receive the X-rays after they have passed through the view regions 21 to obtain the images for each of the view regions 21 of the test object 2. The reconstruction module 16 is connected to the detectors 14 and is configured to receive the images from the detectors 14 to reconstruct a 3D tomographic image for each of the view regions 21 of the test object 2 based on the images.

In the present embodiment, the imaging regions 1011 in the stage 10 refers to a region toward which the X-ray generator 12 emits X-rays and from which the X-rays are received by the detector 14 to obtain images. The imaging regions 1011 are arranged in an array as shown in FIG. 3; however, the arrangement is not limited to FIG. 3. The detectors 14 are also arranged in an array and correspond to the imaging regions 1011. Therefore, the X-rays passing through the imaging regions 1011 can be received by the corresponding detectors 14 to form images. Wherein, the number of the detectors 14 and the imaging regions 1011 is 9 each, but in practice, this is not limited to this quantity. The number of detectors and imaging regions can be adjusted according to user requirements. The moving unit 100 drives the test object 2 sequentially through the imaging regions 1011 by a scanning motion. Specifically, the test object 2 can move row by row along a moving direction from a diagonal position of the stage 10 and alternately change the movement direction between the adjacent rows to form a movement path. This continues until the test object 2 sequentially moves through the imaging regions 1011 to the other diagonal position of the stage 10. However, in practice, this is not limited to this method and may also include scanning methods where the movement direction remains unchanged between adjacent rows.

In the present embodiment, when the test object 2 moves within the zone 101, a single detector among the detectors 14 obtains the plurality of images of the view regions 21 from the same angle at a plurality of time points. Furthermore, since the X-rays emitted simultaneously by the X-ray generator 12 reach the plurality of imaging regions 1011, the plurality of detectors 14 obtain images of the view regions 21 of the test object 2 within their respective corresponding imaging regions 1011 from different angles at the same time point. Specifically, when the test object 2 is placed on the moving unit 100 and the moving unit 100 is disposed within the zone 101 of the stage 10, the test object 2 moves across the plurality of imaging regions 1011 as it moves from a diagonal position to the other diagonal position. Under the aforementioned condition, the plurality of detectors 14 can operate synchronously to respectively obtain images of different angles for the view regions 21 of the test object 2 at the same time point. Additionally, each time the moving unit 100 moves, one of the view regions 21 of the test object 2 then enters the imaging regions 1011 corresponding to the next detector 14. It enables, at different time points during the movement process, images of the same view region 1011 to be obtained from different angles by different detectors 14, and the same detector 14 to sequentially obtain images of the same angle for the plurality of view regions 21. Namely, compared to prior art, which requires imaging a single view region of a test object from multiple angles before performing the same imaging process at multiple angles for another view region, repeating it until all view regions are imaged, the present invention can simultaneously perform imaging for the plurality of view regions 21 and complete the process as the test object 2 moves. Not only have different detectors 14 obtained corresponding images for the same view region 21 of the test object 2 from different angles, but multiple images of different regions 21 have also been obtained from different angles, respectively, thereby effectively reducing the imaging time for the test object 2.

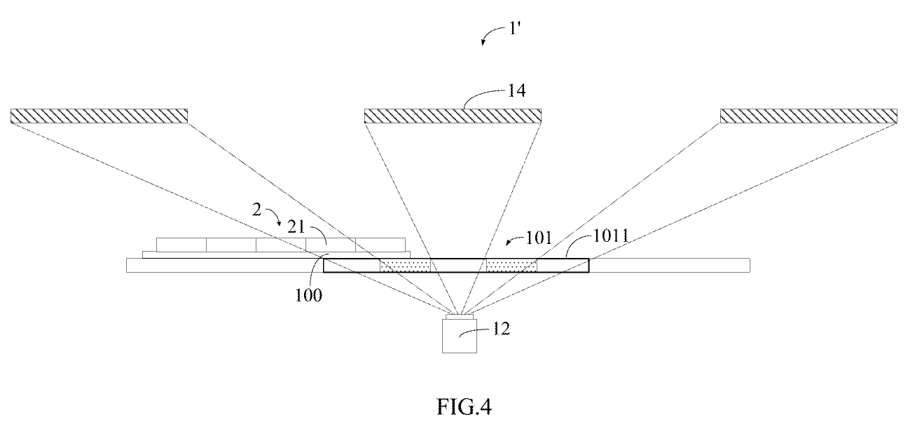

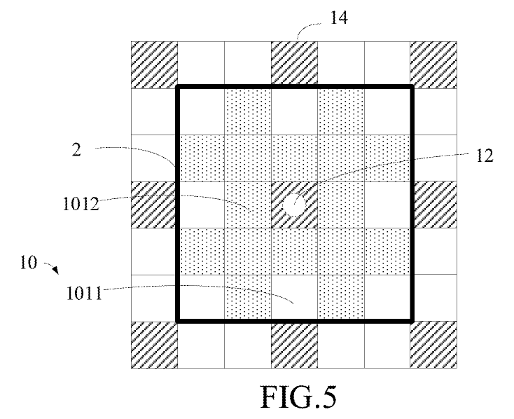

Please refer to FIGS. 4 and 5 . FIG. 4 is a front-view schematic diagram illustrating a multi-channel fast X-ray computed tomography apparatus 1’ according to another embodiment of the present invention. FIG. 5 is a top-view schematic diagram illustrating the multi-channel fast X-ray computed tomography apparatus 1’ according to another embodiment of the present invention. As shown in FIGS. 4 and 5 , the present embodiment differs from the above embodiment in that the imaging regions 1011 of the stage 10 further include an interval 1012. In practice, the interval 1012 is standardized based on the size of one imaging region, though it may also be set to 0.8 or 0.9 imaging regions to facilitate 3D image reconstruction. The size of the interval 1012 is determined according to user requirements. The above interval 1012 is configured to address the issue of imaging blind spots at the junctions of adjacent imaging regions 1011. The imaging blind spots form when the adjacent imaging regions 1011 contact each other, due to limitations in the outer casing of the detectors 14 that cannot receive images. It should be noted that other components in the multi-channel fast X-ray computed tomography apparatus 1’ of the present embodiment are substantially the same as the corresponding components in the above embodiment, and are therefore not repeated herein.

Specifically, as shown in FIG. 4, in the present embodiment, the detectors 14 are disposed at intervals along the movement direction of the test object 2 and correspond to the imaging regions 1011 to obtain a plurality of images by receiving X-rays passing through corresponding imaging regions from different angles. The test object 2 has a plurality of view regions 21 arranged sequentially along the movement direction, including a first view region, a second view region, a third view region, a fourth view region, and a fifth view region. When the first view region (the rightmost view region 21) of the test object 2 moves into a leftmost imaging region 1011 of the zone 101, a leftmost detector 14 can receive the X-rays passing through the imaging region 1011 to obtain an image of the first view region at a first angle. When the test object 2 moves again, the first view region of the test object 2 enters the interval 1012 between the imaging regions, and the second view region (the second view region 21 from the right) enters the leftmost imaging region 1011. This enables the leftmost detector 14 to receive the X-rays passing through the imaging region 1011, thereby obtaining an image of the second view region at the first angle. When the test object 2 moves continuously, the first view region enters a central imaging region 1011, the second view region enters the interval 1012 of the imaging region 1011, and the third test imaging region (the central view region 21) enters the leftmost imaging region 1011. At this time, a central detector 14 can obtain an image of the first view region at a second angle, and the leftmost detector 14 can obtain an image of the third view region at the first angle. Subsequently, when the first view region moves continuously into a rightmost imaging region 1011, a rightmost detector 14 can obtain an image of the first view region at a third angle, the central detector 14 can obtain an image of the third view region at the second angle, and the leftmost detector 14 can obtain an image of the fifth view region at the first angle. Until the five aforementioned view regions of the test object 2 move out of the zone 101, a plurality of images of these view regions are obtained from different angles. It should be noted that the various angles mentioned above refer to a central angle of each of the detectors relative to a light source, while the actual imaging range extends outward from the central angle by a predetermined angle. For example, the central angle of the detector and the imaging region, both positioned at the center in FIG. 4, with respect to the light source is 90 degrees. The images obtained by the central detector fall within a range extending a specific angle (such as 5 degrees or 10 degrees) from 90 degrees on either side. Wherein, the number of the interval 1012 between the adjacent imaging region 1011 may be 1, 2, or 3, but in practice, this is not limited to these values.

In another embodiment, the multi-channel fast X-ray computed tomography apparatus 1’ can further selectively include a mask module (not shown) disposed between the X-ray generator 12 and the stage 10 and corresponding to at least one interval 1012. The mask module is configured to block X-rays emitted by the X-ray generator 12 from passing through at least one interval 1012, thereby reducing the cumulative radiation dose of the test object 2.

Furthermore, the present invention can switch between the present embodiment and the above embodiment by adjusting the height of the imaging regions 1011 of the stage 10 and its corresponding detector 14. It enables the present invention to generate multiple images of the present embodiment and the images from the above embodiment for the test object 2, which are then used together for 3D image reconstruction to obtain more images and enhance the effectiveness of 3D reconstruction.

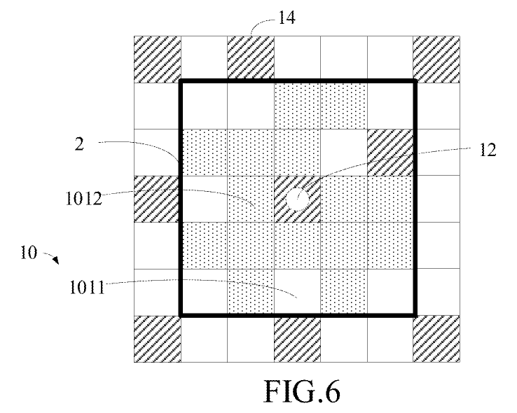

Please refer to FIG. 6.FIG. 6 is a top-view schematic diagram illustrating the multi-channel fast X-ray computed tomography apparatus 1’ according to another embodiment of the present invention. As shown in FIG. 6, the present embodiment differs from the above embodiment in that the detectors are not arranged in an array but can be freely arranged according to user requirements. Therefore, the detectors in the present embodiment can obtain images from different angles compared to the above embodiment. Additionally, depending on the arrangement of the detector 14, the corresponding imaging regions 1011 within the stage 10 also differ. Namely, the number of intervals 1011 between the plurality of the imaging regions also differs.

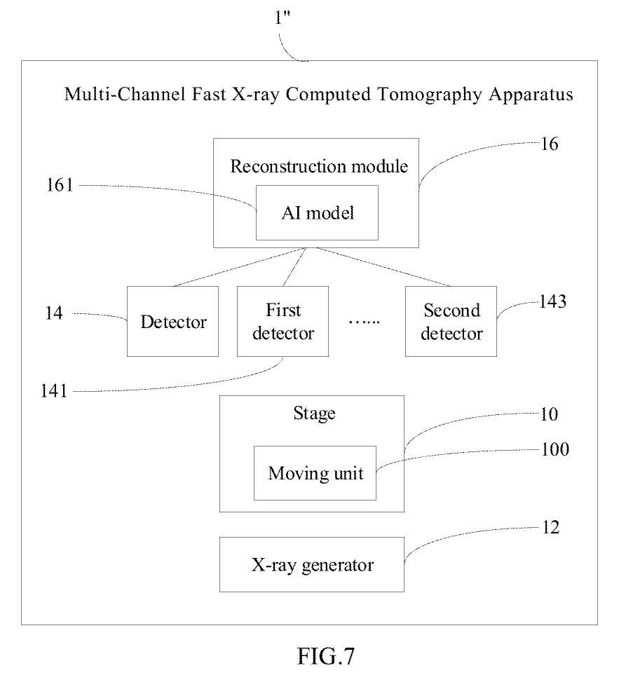

Please refer to FIG. 7. FIG. 7 is a schematic diagram illustrating the multi-channel fast X-ray computed tomography apparatus 1” according to another embodiment of the present invention. As shown in FIG. 7, the present embodiment differs from the above embodiment in that the reconstruction module 16 of the multi-channel fast X-ray computed tomography apparatus 1” further includes an artificial intelligence (AI) model 161, and the detectors 14 include at least one of a first detector 141 and a second detector 142. It should be noted that other components in the multi-channel fast X-ray computed tomography apparatus 1” of the present embodiment are substantially the same as the corresponding components in the multi-channel fast X-ray computed tomography apparatus 1 of the above embodiment, and are therefore not repeated herein.

In the present embodiment, the first detector 141 among the detectors 14 includes only a single detecting surface configured to obtain the images of the plurality of view regions from the same angle at a plurality of time points. Additionally, the second detector 142 among the detectors 14 can include a first detecting surface and a second detecting surface, which respectively receive X-rays from different angles to generate images at those angles. This enables the obtaining of images from more angles while maintaining the same number of detectors. Wherein, the first detecting surface and the second detecting surface are formed by partitioning one detecting surface of the second detector through software. However, in practice, the detecting surfaces are not limited to the two partitions partitioned by the software (that is, the first detecting surface and the second detecting surface). Users may also add additional partitions based on actual detection requirements.

In the present embodiment, the reconstruction module 16 includes at least one AI model 161 configured to perform a denoising process on the images to generate a high-quality two-dimensional image, perform a sparse 3D reconstruction process on the high-quality two-dimensional image to generate a full-view 3D image, and perform a super-resolution process on the full-view 3D image to generate a high-resolution 3D tomographic image. In a practical application, the process by which at least one AI model generates a high-resolution 3D tomographic image by performing the super-resolution process on the full-view 3D image may specifically involve re-slicing the full-view 3D image into 2D distribution images of multiple layers. The AI model then selects the necessary layers for super-resolution processing and subsequently generates the high-resolution 3D tomographic image. Compared to performing the super-resolution process on all layers, the above approach only performs the super-resolution process on the necessary layers, which can further reduce the computational load of the at least one AI model to enhance efficiency. However, in practice, whether to perform the super-resolution process on full-view 3D images can be adjusted according to user requirements. Wherein training datasets used for training the at least one AI model 161 comprise datasets of long-exposure images and short-exposure images for different sample forms, datasets of large-angle images and small-angle images, and datasets of segmented and non-segmented images for imaging regions.

Furthermore, the at least one AI model 161 can include an artifact removal model configured to perform a super-resolution process on the full-view 3D image to generate a high-resolution 3D tomographic image. Namely, the artifact removal model can detect artifact structure based on full-view 3D images and remove the artifact structure to generate high-resolution 3D tomographic images. The artifact removal model is trained by learning the corresponding relationships between a full-view 3D image of a reference object, reconstructed from T 2D images, and a high-resolution 3D tomographic image, reconstructed from P 2D images, where P > T. That is, the present invention can generate high-resolution 3D tomographic images from a small number of images of a test object using the artifact removal model to reduce the number of images required and shorten the detection time, thereby enhancing overall imaging efficiency and precision.

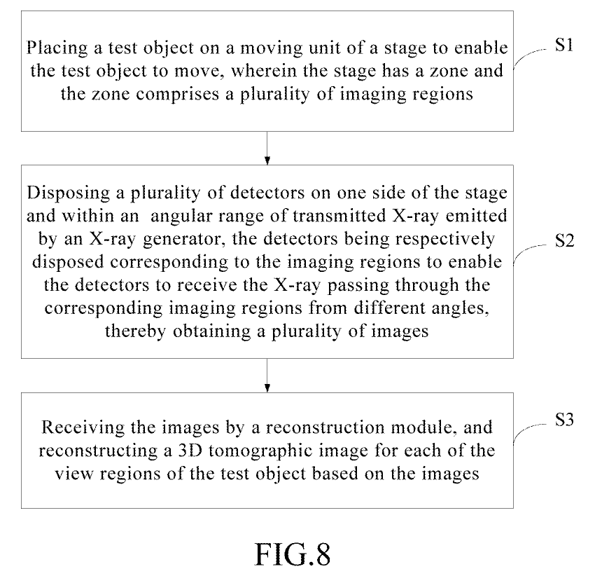

Please refer to FIG. 8. FIG. 8 is a flow diagram illustrating a multi-channel fast X-ray computed tomography method according to an embodiment of the present invention. As shown in FIG. 8, in the present embodiment, the multi-channel fast X-ray computed tomography method includes the following steps: step S1: placing a test object on a moving unit of a stage to enable the test object to move, wherein the stage has a zone and the zone comprises a plurality of imaging regions; step S2: disposing a plurality of detectors on one side of the stage and within a angular range of transmitted X-ray emitted by an X-ray generator, the detectors being respectively disposed corresponding to the imaging regions to enable the detectors to receive the X-ray passing through the corresponding imaging regions from different angles, thereby obtaining a plurality of images; and step S3: receiving the images by a reconstruction module, and reconstructing a 3D tomographic image for each of the view regions of the test object based on the images. Wherein, the moving unit drives the test object from outside the imaging regions into the zone and moves the test object within the zone by scanning motion. When the test object moves within the zone, a plurality of view regions of the test object sequentially pass through the imaging regions, and the detectors obtain the images for each of the view regions of the test object. Please note that the method shown in FIG. 8 can be achieved using either the multi-channel fast X-ray computed tomography apparatus 1 of FIG. 1 or the multi-channel fast X-ray computed tomography apparatus 1' of FIG. 4.

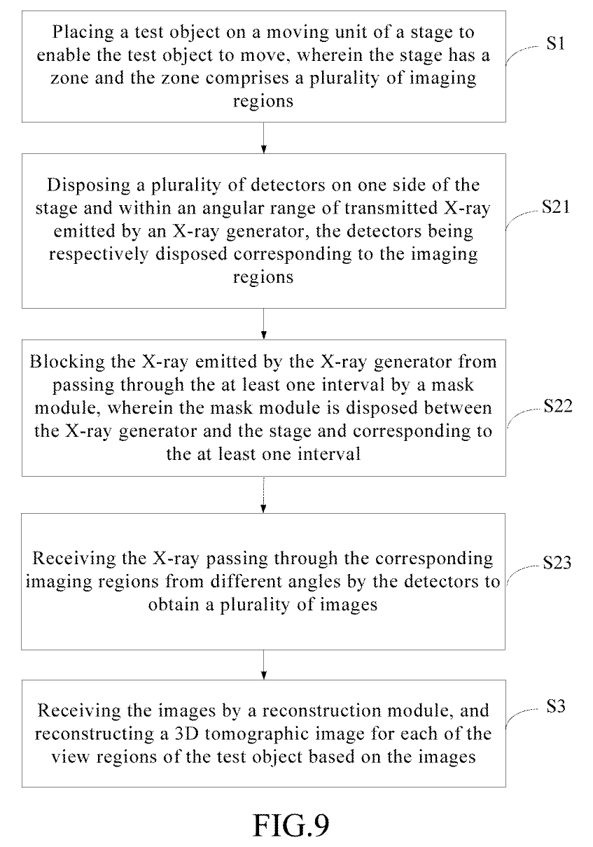

Please refer to FIG. 9. FIG. 9 is a flow diagram illustrating a multi-channel fast X-ray computed tomography method according to another embodiment of the present invention. As shown in FIG. 9, in the present embodiment, the method of the present embodiment differs from the method of the above embodiment in that the step S2 further includes steps S21 to S23. Step S21: disposing a plurality of detectors on one side of the stage and within an angular range of transmitted X-ray emitted by an X-ray generator, the detectors being respectively disposed corresponding to the imaging regions; step S22: blocking the X-ray emitted by the X-ray generator from passing through the at least one interval by a mask module, wherein the mask module is disposed between the X-ray generator and the stage and corresponding to the at least one interval; and step S23: receiving the X-ray passing through the corresponding imaging regions from different angles by the detectors to obtain a plurality of images. Please note that the method shown in FIG. 9 can be achieved using the multi-channel fast X-ray computed tomography apparatus 1' of FIG. 4.

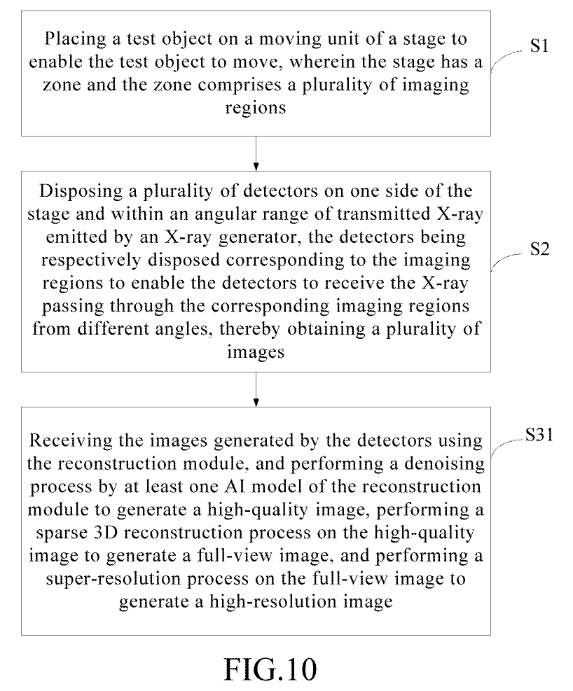

Please refer to FIG. 10. FIG. 10 is a flow diagram illustrating a multi-channel fast X-ray computed tomography method according to another embodiment of the present invention. As shown in FIG. 10, the method of the present embodiment differs from the method of the above embodiment in that the step S3 further includes step S31: receiving the images generated by the detectors using the reconstruction module, and performing a denoising process by at least one AI model of the reconstruction module to generate a high-quality image, performing a sparse 3D reconstruction process on the high-quality image to generate a full-view image, and performing a super-resolution process on the full-view image to generate a high-resolution image. Wherein training datasets used for training the at least one AI model comprises datasets of long-exposure images and short-exposure images for different sample forms, datasets of large-angle images and small-angle images, and datasets of segmented and non-segmented images for imaging regions. The multi-channel fast X-ray computed tomography method of the present embodiment can generate high-resolution 3D tomographic images using only a small number of images of a test subject through at least one AI model, thereby enhancing efficiency and image accuracy. Please note that the method shown in FIG. 10 can be achieved using the multi-channel fast X-ray computed tomography apparatus 1” of FIG. 7.

In summary, the present invention not only obtains images of a single view region. Rather, it simultaneously obtains images for a plurality of imaging regions from different angles by a plurality of detectors based on the movement of a test object on a stage to shorten imaging time, thereby reducing the cumulative radiation dose of the test object and ensuring it remains undamaged after detection. At the same time, the present invention can also perform multiple rounds of repeated scanning by adjusting the position of the imaging regions of the stage and its corresponding detectors to obtain more images, thereby enhancing the performance of subsequent 3D reconstruction. Additionally, the detectors of the present invention can be partitioned into multiple detecting surfaces by software to generate more images from different angles, thereby facilitating subsequent 3D reconstruction. Furthermore, the present invention can also include an image processing module, which performs three-dimensional reconstruction on a plurality of images using at least one AI model, detects and removes artifacts to generate a high-resolution 3D tomographic image.

With the examples and explanations mentioned above, the features and spirits of the present invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A multi-channel fast X-ray computed tomography apparatus, comprising:
a stage, comprising a moving unit, the moving unit being configured to carry and drive a test object to move, the stage having a zone, the zone comprising a plurality of imaging regions;
an X-ray generator, disposed on one side of the stage and configured to emit an X-ray toward the zone of the stage; and
a plurality of detectors, disposed on the other side of the stage and within an angular range of transmitted X-rays, the detectors being respectively disposed corresponding to the imaging regions to receive the X-ray passing through the corresponding imaging regions from different angles to obtain a plurality of images;
wherein, the moving unit drives the test object from outside the imaging regions into the zone and moves the test object within the zone in a scanning motion, when the test object moves within the zone, a plurality of view regions of the test object sequentially pass through the imaging regions, a first detector of the detectors obtains the images of the view regions from the same angle at a plurality of time points, and the detectors respectively obtain the images of the view regions from different angles at the same time point.

2. The multi-channel fast X-ray computed tomography apparatus of claim 1, wherein the detectors are arranged in 2x2, 3x3 or non-uniform array.

3. The multi-channel fast X-ray computed tomography apparatus of claim 1, further comprising a reconstruction module connected to the detectors, the reconstruction module is configured to receive the images from the detectors and reconstruct a 3D tomographic image for each of the view regions of the test object based on the images.

4. The multi-channel fast X-ray computed tomography apparatus of claim 1, wherein a second detector of the detectors comprises a first detecting surface and a second detecting surface, the first detecting surface and the second detecting surface respectively receive the X-ray from different angles to generate the images at different angles, wherein the first detecting surface and the second detecting surface are formed by partitioning one detecting surface of the second detector through a software.

5. The multi-channel fast X-ray computed tomography apparatus of claim 1, wherein the reconstruction module comprises an image processing model configured to enhance image quality and/or reconstruct a high-resolution 3D tomographic image from sparsely acquired projection data.

6. The multi-channel fast X-ray computed tomography apparatus of claim 5, wherein the image processing model comprises at least one artificial intelligence (AI) model, the at least one AI model is configured to perform a denoising process on the images to generate a high-quality two-dimensional image, perform a sparse 3D reconstruction process on the high-quality two-dimensional image to generate a full-view 3D image, and perform a super-resolution process on the full-view 3D image to generate the high-resolution 3D tomographic image, wherein a training dataset used for training the at least one AI model comprises datasets of long-exposure images and short-exposure images for different sample forms, datasets of large-angle images and small-angle images, and datasets of segmented and non-segmented images for imaging regions.

7. The multi-channel fast X-ray computed tomography apparatus of claim 1, wherein the imaging regions are arranged in an array, and at least one interval is disposed between the adjacent imaging regions.

8. The multi-channel fast X-ray computed tomography apparatus of claim 7, further comprising a mask module disposed between the X-ray generator and the stage and corresponding to the at least one interval, the mask module being configured to block the X-ray emitted by the X-ray generator from passing through the at least one interval.

9. The multi-channel fast X-ray computed tomography apparatus of claim 1, wherein the scanning motion comprises continuous movement along a scanning path comprising at least one of a serpentine scanning path, a raster scanning path, and a zig-zag scanning path.

10. A multi-channel fast X-ray computed tomography method, comprising the following steps:
placing a test object on a moving unit of a stage to enable the test object to move, wherein the stage has a zone and the zone comprises a plurality of imaging regions; and
disposing a plurality of detectors on one side of the stage and within an angular range of transmitted X-rays emitted by an X-ray generator, the detectors being respectively disposed corresponding to the imaging regions to enable the detectors to receive the X-ray passing through the corresponding imaging regions from different angles, thereby obtaining a plurality of images;
wherein, the moving unit drives the test object from outside the imaging regions into the zone and moves the test object within the zone by scanning motion, when the test object moves within the zone, a plurality of view regions of the test object sequentially pass through the imaging regions, a first detector of the detectors obtains the images of the view regions from the same angle at a plurality of time points, and the detectors respectively obtain the images of the view regions from different angles at the same time point.

11. The multi-channel fast X-ray computed tomography method of claim 10, further comprising the following step:
receiving the images by a reconstruction module, and reconstructing a 3D tomographic image for each of the view regions of the test object based on the images.

12. The multi-channel fast X-ray computed tomography method of claim 10, wherein a second detector of the detectors comprises a first detecting surface and a second detecting surface, the first detecting surface and the second detecting surface respectively receive the X-ray from different angles to generate the images at different angles, wherein the first detecting surface and the second detecting surface are formed by partitioning one detecting surface of the second detector through a software.

13. The multi-channel fast X-ray computed tomography method of claim 10, further comprising the following step:
using the reconstruction module to enhance image quality and/or reconstruct a high-resolution 3D tomographic image from sparsely acquired projection data.

14. The multi-channel fast X-ray computed tomography method of claim 13, further comprising the following step:
receiving the images generated by the detectors using the reconstruction module, and performing a denoising process by at least one AI model of the reconstruction module to generate a high-quality image, performing a sparse 3D reconstruction process on the high-quality image to generate a full-view image, and performing a super-resolution process on the full-view image to generate a high-resolution image;
wherein a training dataset used for training the at least one AI model comprises datasets of long-exposure images and short-exposure images for different sample forms, datasets of large-angle images and small-angle images, and datasets of segmented and non-segmented images for imaging regions.

15. The multi-channel fast X-ray computed tomography method of claim 11, wherein the imaging regions are arranged in an array, and at least one interval is disposed between the adjacent imaging regions.

16. The multi-channel fast X-ray computed tomography method of claim 15, further comprising the following step:
blocking the X-ray emitted by the X-ray generator from passing through the at least one interval by a mask module, wherein the mask module is disposed between the X-ray generator and the stage and corresponding to the at least one interval.

17. The multi-channel fast X-ray computed tomography apparatus of claim 10, wherein the scanning motion comprises continuous movement along a scanning path comprising at least one of a serpentine scanning path, a raster scanning path, and a zig-zag scanning path.

18. A multi-channel fast X-ray computed tomography apparatus, comprising:
an X-ray generator, configured to emit an X-ray toward a test object; and
a plurality of detectors, configured to receive the X-rays after passing through the test object to obtain projection data, wherein the projection data corresponding to a same region of the test object are acquired from different angular perspectives across the plurality of detectors and across different time points during continuous relative motion between the test object and the detectors.
